(19) United States
(12) Patent Application Publication
(10) Pub. No.: US 2023/0052822 A1
(43) Pub. Date: Feb. 16, 2023

(54) VEHICLE AND PAINTING METHOD

(71) Applicant: TOYOTA JIDOSHA KABUSHIKI KAISHA, Toyota-shi (JP)

(72) Inventors: Yukinori II, Toyota-shi (JP); Kenji YAMAGUCHI, Miyoshi-shi (JP); Junya OGAWA, Okazaki-shi (JP); Yuki NAGANUMA, Nagoya-shi (JP); Junya YAMAMOTO, Seto-shi (JP); Yuta TONE, Nagoya-shi (JP); Naoki ISHIZUKA, Nagoya-shi (JP); Tadayuki TANAKA, Nagoya-shi (JP); Keisuke ITO, Okazaki-shi (JP); Yuka YOKOI, Miyoshi-shi (JP); Takashi HAYASHI, Nagoya-shi (JP); Naoya OKA, Nagakute-shi (JP); Yu HAMADA, Nagoya-shi (JP)

(73) Assignee: TOYOTA JIDOSHA KABUSHIKI KAISHA, Toyota-shi (JP)

(21) Appl. No.: 17/885,905

(22) Filed: Aug. 11, 2022

(30) Foreign Application Priority Data
Aug. 11, 2021 (JP) 2021-131084

(51) Int. Cl. B05D 7/00

(52) U.S. Cl. CPC B05D 7/577; B05D 2401/40; B05D 2451/00

(57) ABSTRACT

A vehicle comprises a first paint film that is formed on a first section of a vehicle body and is later peelable; and a second paint film that is formed on a second section and is not continuous with the first paint film, the second section being invisible from the outside of the vehicle body.

### CROSS REFERENCE TO THE RELATED APPLICATION

This application claims the benefit of Japanese Patent Application No. 2021-131084, filed on Aug. 11, 2021, which is hereby incorporated by reference herein in its entirety.

### BACKGROUND

### Technical Field

This disclosure relates to a vehicle.

### Description of the Related Art

Technology is known for removing scratches along with the painting by peeling the top coat of paint on the car body (see, for example, Japanese Patent Laid-Open No. 8-150369).

### SUMMARY

An object of this disclosure is to accurately determine the paint condition of a vehicle.

The present disclosure in its one aspect provides a vehicle comprising: a first paint film that is formed on a first section of a vehicle body and is later peelable; and a second paint film that is formed on a second section and is not continuous with the first paint film, the second section being invisible from the outside of the vehicle body.

The present disclosure in its another aspect provides a painting method comprising: a first step of forming a first paint film that is later peelable, on a first section of a vehicle body of a vehicle; and a second step of forming a second paint film on a second section, the second paint film not being continuous with the first paint film, the second section being invisible from the outside of the vehicle body.

Another aspect of this disclosure is a method of manufacturing a vehicle as described above, a program for causing a computer to execute the aforementioned painting method, or a computer readable storage medium non-transiently storing the program.

According to this disclosure, the paint condition of a vehicle can be accurately determined.

### BRIEF DESCRIPTION OF THE DRAWINGS

FIG. 1 is a perspective view of a vehicle according to an embodiment;

FIG. 2 is a cross-sectional view of a hood;

FIG. 3A is a schematic diagram of painting with an easy-to-peel paint;

FIG. 3B is a schematic diagram of painting with an easy-to-peel paint;

FIG. 4 is a cross-sectional view of the hood and a front fender;

FIG. 5 is a diagram for explaining the state where paint has been peeled;

FIG. 6 is a cross-sectional view of a front door and rocker panel molding;

FIG. 7 is a perspective view of the front door and the rocker panel molding;

FIG. 8 is a perspective view of a roof rail and a roof panel; and

FIG. 9 is a flowchart of the painting procedure.

### DESCRIPTION OF THE EMBODIMENTS

There is technology for applying peelable paint to the body of a vehicle, using a paint film including an easy-to-peel layer.

Since such a paint film can be easily peeled, the vehicle body color can be changed at any time. This makes it possible, for example, to select a vehicle body color that is popular in the used car market when purchasing a vehicle, top-coating it with a paint in one's favorite color, and then return it to the original color when selling it. Besides, top-coating protects the original paint film, thereby making the value of the used vehicle higher than without top-coating.

In this specification, “top-coat” is to form a later peelable paint film on top of the original paint film of the vehicle. Also, “peel (paint)” is to remove the peelable paint film. Also, “top coat paint” is a peelable paint applied over an existing paint film, using a paint film including an easy-to-peel layer.

In this specification, a “paint film” refers to a film of paint applied in the process of painting, a peelable film, or a combination of these.

As such a system that allows paint to be easily top-coated is widespread, it is expected to become more difficult to estimate the history of a vehicle based on the appearance of the vehicle body alone. For example, immediately after the top coat paint is peeled, the vehicle looks like a new vehicle, so that the condition and appearance of a vehicle may not match. Besides, if a vehicle accident occurs and the body paint film is scratched, peeling the top coat paint may conceal the accident history.

The vehicle according to this disclosure solves such problems.

A vehicle according to a first aspect of this disclosure is a vehicle that has a first later peelable paint film and a second later peelable paint film that are formed on the vehicle body. To be specific, the first paint film is formed on a first section, the second paint film of the same color as the first paint film is formed on a second section that is invisible from the outside of the vehicle, and the first and second paint films are not continuous at the boundary between the first and second sections.

A later peelable paint film refers to a paint film that can be applied to the vehicle body and is peelable at any time. A paint film that includes an easy-to-peel layer may be, for example, a combination of a peelable film and a normal paint film, or a colored paint film that is itself peelable (hereinafter referred to as “easy-to-peel paint”).

Forming a paint film containing an easy-to-peel layer on top of the vehicle's original paint film allows the top coat paint to be later peeled (i.e., the vehicle body color can be restored). The top coat paint film can be easily peeled by applying external force.

The vehicle according to this disclosure has paint films of the same color on the first and second sections. The second section is a section that is invisible from the outside of the vehicle in normal usage. At the boundary between the first and second sections, the first and second paint films are not continuous.

In such a configuration, when an attempt is made to remove the first paint film, a second paint film remains in an area that is invisible from the outside of the vehicle. This allows the evidence that “the peelable paint film has been removed for some reason” to be left on the vehicle body.

Specific embodiments of this disclosure will be described below with reference to the attached drawings. The configurations and the like described in each embodiment are not intended to limit the technical scope of the disclosure to them alone, unless otherwise stated.

### First Embodiment

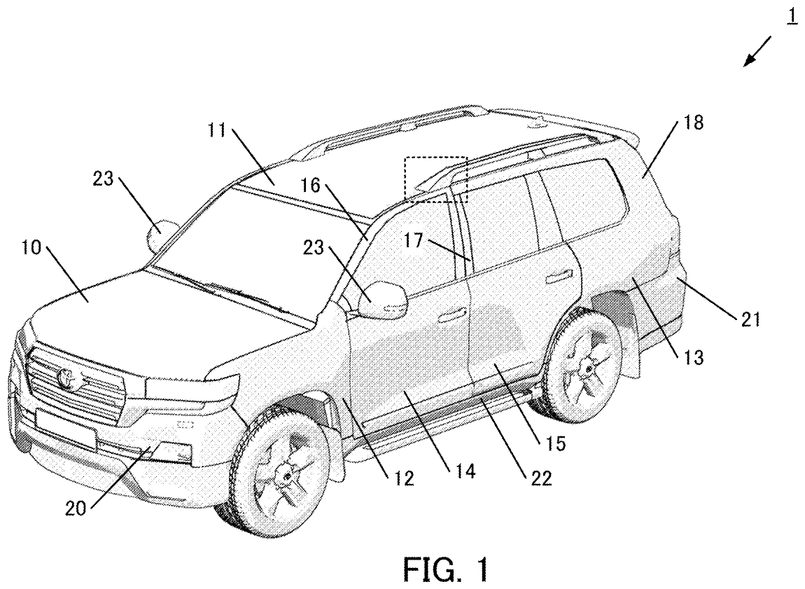

FIG. 1 is a perspective view of a vehicle 1 according to this embodiment. The vehicle 1 has multiple exterior panels and exterior components. The exterior panels are components forming the vehicle body and include a hood 10, a roof panel 11, a front fender panel 12, a rear fender panel 13, a front door outer 14, a rear door outer 15, a front pillar 16, a center pillar 17, a rear pillar 18, and the like. The exterior panels are typically steel plates and are painted in a predetermined color upon manufacture of the new car.

The exterior components are outfitting components that are assembled into the vehicle body. Exterior components are made of resin, for example. Examples of exterior components include a front bumper 20, a rear bumper 21, a rocker panel molding 22, and side mirrors 23. Like the exterior panels, the exterior components are painted in a predetermined color upon manufacture of the new car. Some of the exterior components may be either painted in a color different from the aforementioned colors, or unpainted.

A paint film including an easy-to-peel layer is formed on each of the exterior panels and exterior components. The vehicle body color can be changed by overlaying a paint film including an easy-to-peel layer on the outer surface and side edge surfaces (or part of the rear surface) of the exterior panels and exterior components having a predetermined body color. The exterior panels and exterior components will hereinafter be referred to as body members.

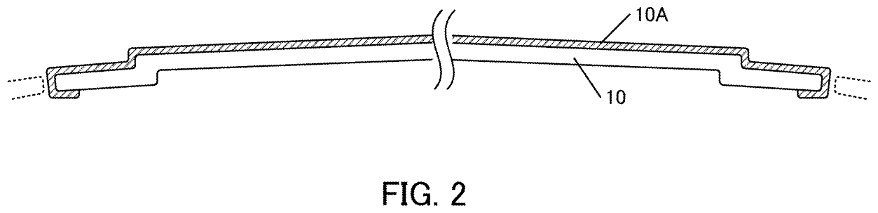

FIG. 2 illustrates where such a coating film is formed. FIG. 2 illustrates a cross-section of the hood 10. The upper side to the viewer is the exterior side of the vehicle, and the lower side is the engine compartment side. The reference numeral 10 indicates an exterior panel, and the hatched area (reference numeral 10A) indicates the paint film including the easy-to-peel layer. The hood 10 is supposed to be painted in a predetermined color upon manufacture of the vehicle.

The dotted line represents the front fender panel. As shown in the drawing, the paint film including the easy-to-peel layer is formed in a spot where it is visible from the outside of the vehicle body.

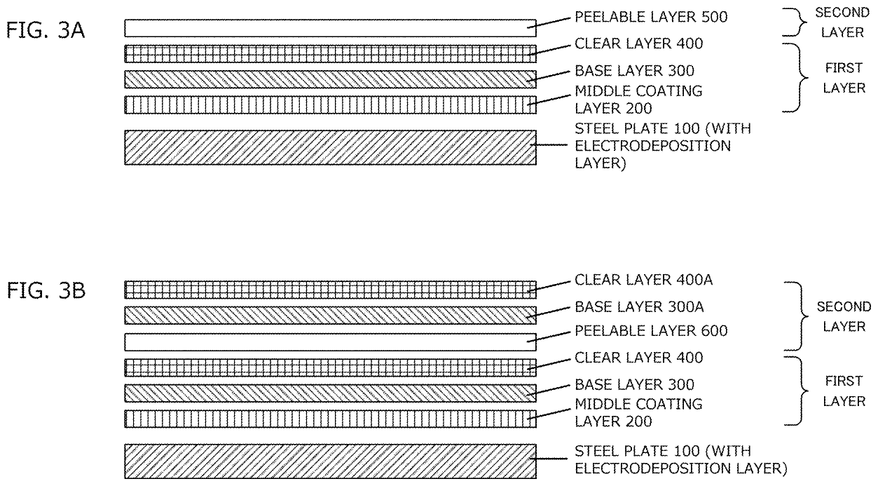

The following is a brief description of the paint film including the easy-to-peel layer. FIG. 3A is a schematic cross-sectional view of a body member (e.g., steel plate) included in the vehicle body, and a paint film applied to the body member. As shown in the drawing, the body member includes a metal-processed steel plate 100 with an electrodeposition layer, and a middle coating layer 200, a base layer 300, and a clear layer 400 formed in this order on the electrodeposition layer. These layers correspond to the first layer of paint (the original paint that the vehicle has).

On the outer surface of the body member, a peelable layer 500 is formed as the second layer of paint. The peelable layer 500 is a layer of paint with easy-to-peel properties (easy-to-peel paint), which can be easily peeled by applying force compared to the normal paint film. The peelable layer 500 is the “easy-to-peel layer” in this disclosure, and the paint film depicted as the second layer is the “paint film including the easy-to-peel layer.” The peelable layer 500 is formed by coating the body member with an easy-to-peel paint, for example, by spraying. Examples of the easy-to-peel paint include paints containing xylene, ethyl benzene, antioxidants, methyl ethyl ketone, silica reactants, titanium dioxide (nanoparticles), organic solvents, and the others.

Vehicles can be top-coated with an easy-to-peel paint at a given base location for vehicle. This allows the vehicle body color to be easily changed (i.e., from the first body color to the second body color). The same applies to the peeling of the peelable layer 500. Peeling the peelable layer 500 at a given base location for vehicle allows the vehicle body color to be returned to the original color (i.e., from the second body color to the first body color).

Although a steel plate is illustrated as the body member in this example, the body member may be a resin member. In this case, the middle coating layer 200 is a primer layer. A clear layer may additionally be provided on top of the peelable layer 500. The clear layer can provide a glossy finish and improve weather resistance.

Although FIG. 3A illustrates the example case where the paint itself is given easy-to-peel properties, a normal paint may be applied over a layer with easy-to-peel properties. For example, as shown in FIG. 3B, an uncolored peelable layer 600 of the same material as the peelable layer 500 may be formed, and a base layer 300A and a clear layer 400A may be formed on top of the peelable layer 600. The base layer 300A is a layer of paint with a color different from that of the base layer 300. Even in such a mode, the layer of paint can be removed by peeling the peelable layer 600. In this case, the peelable layer 600 is an “easy-to-peel layer” in this disclosure, and the paint film depicted as the second layer is a “paint film including the easy-to-peel layer.”

Although one color is illustrated as the body color and the topcoat color in this example, coating may be performed using multiple colors. For example, multiple colors arranged in a predetermined pattern may be used as the body color. Also, a “color” herein may be represented by not only a single layer but multiple layers of paints or materials. The multiple layers may include, for example, a clear layer, a glass flake layer, a mica layer, and a pearl layer.

Top coating may be applied to at least a portion of the original paint. In other words, the top coating may cover not the entire original paint. For example, if the original body color is black, a two-tone black and blue vehicle can be obtained by applying a blue top coat to a portion thereof.

In this embodiment, the paint film formed on the first section and the paint film formed on the second section are independent of each other and not continuous with each other. The first section is a section that is at least partially visible from the outside when an opening, such as the hood, trunk lid, or doors, is closed. The first section may include both an area located on the front side of the body member and an area lying on the rear side of the body member.

The second section is a section that is entirely invisible from the outside. The second section may be, for example, a section that is invisible from the outside when the aforementioned opening is closed.

The locations of the first and second sections will be explained in detail with reference to the drawings.

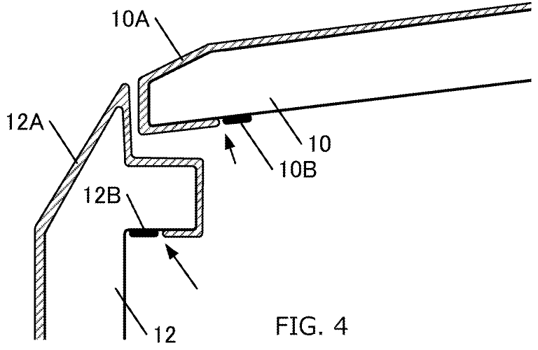

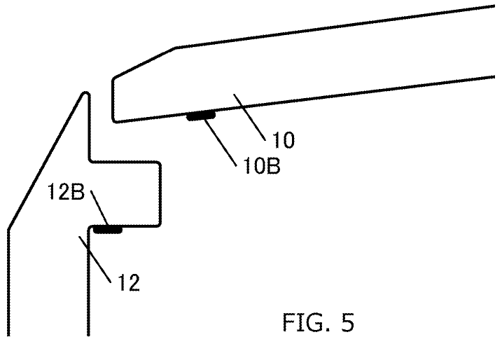

FIG. 4 is an enlarged cross-sectional view of the edge of the hood 10 and the edge of the front fender panel 12. The closer-and-further direction to the viewer of the drawing is the front-and-rear direction of the vehicle. The hatched areas (reference numerals 10A and 12A) are the first sections, and the black areas (reference numerals 10B and 12B) are the second sections. The first and second sections are coated with a paint film that includes an easy-to-peel layer. As shown in the drawing, the second section is located inside the engine compartment and is invisible from the outside of the vehicle when the hood is closed. The arrows indicate the boundary between the first and second sections. At each boundary between the first and second sections, the paint film is not continuous. In this state, if a force is applied from outside the vehicle body to peel the easy-to-peel layer, only the paint film corresponding to the first section (10A and 12A) will peel, and the paint film corresponding to the second section (10B and 12B) will remain. This is because the paint films are separated between the first and second sections, and the force to pull off the paint film does not reach the second section. As a result, as shown in FIG. 5, the paint film remains in area that is invisible from the outside. Therefore, a vehicle with residual paint film in a given section can be considered to have a history of removal of a paint film including an easy-to-peel layer.

Note that the edge of the first section and the edge of the second section is preferably within a predetermined distance (preferably from a several centimeters to a several millimeters) or roughly in contact with each other. Placing both sections close together makes it appear as if the paint film is continuous.

Although the second section is located in the engine compartment in this example, the second section may be located in the luggage compartment (e.g., trunk compartment), for example.

The location of the second section will be explained taking another example.

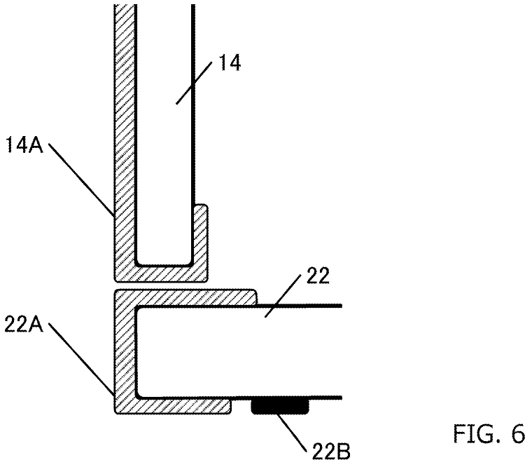

FIG. 6 is a cross-sectional view of the joint between the front door outer 14 and the rocker panel molding 22. As in FIG. 4, the hatched areas (reference numerals 14A and 22A) are the first sections, and the black area (reference numeral 22B) is the second section. The closer-and-further direction to the viewer of the drawing is the front-and-rear direction of the vehicle.

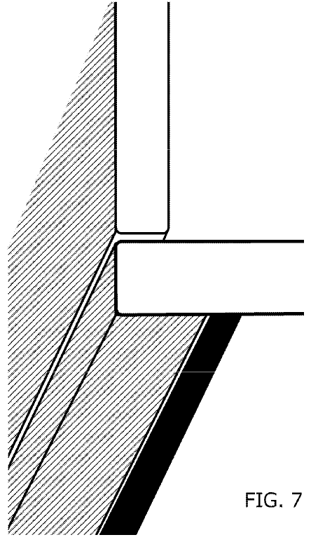

As shown in the drawing, the second section is located at the bottom of the vehicle body, so that the second section is invisible unless the vehicle is jacked up or one looks into the bottom of the body. FIG. 7 is a perspective view of the second section from the bottom of the body. Thus, the second section may be located in a spot that is invisible from a normal viewpoint during use of the vehicle.

Note that the second section may be a section that becomes invisible when an exterior component is installed on the vehicle body. In other words, the second section may be a section that becomes visible when the exterior component is removed. Examples of such an exterior component include a front bumper, a rear bumper, a rocker panel molding, a roof rail, and a roof antenna. Such an exterior component is usually removed during peeling of the paint film.

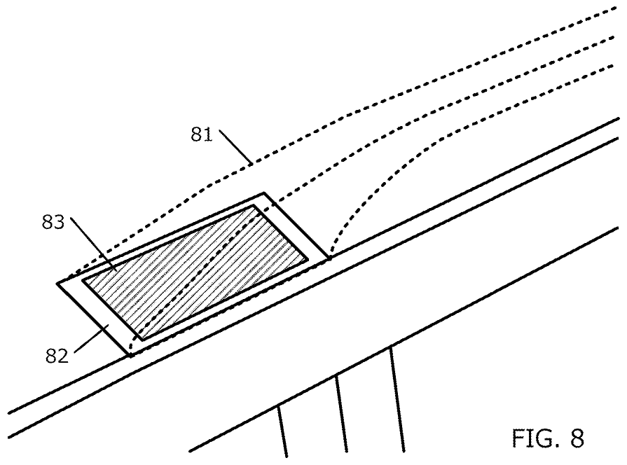

FIG. 8 is a perspective view illustrating an example case when a second section is located on the junction surface between the roof rail and the vehicle body (roof panel). FIG. 8 is an enlarged view of the dotted line portion illustrated in FIG. 1.

The reference numeral 81 indicates the roof rail and the reference numeral 82 indicates the junction surface between the roof rail and the roof panel. The joint surface 82 becomes invisible from the outside when the roof rail is installed. In the drawing, the hatched area (reference numeral 83) is the second section. The boundary between the first and second sections is concealed by the installed roof rail.

Thus, if the easy-to-peel layer is removed without removing the roof rail, the paint film will remain in the hatched area 83. Therefore, a vehicle with a residual paint film on the joint surface between the roof rail and roof panel can be considered to have a history of removal of a paint film including an easy-to-peel layer.

Although this example has illustrated a roof rail, the second section may be located in a spot concealed by any other exterior components.

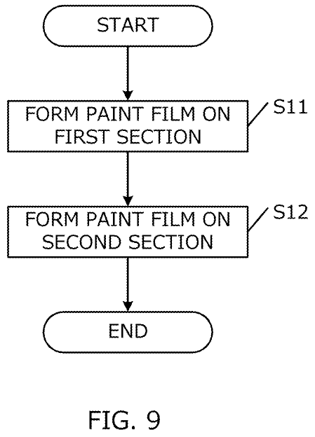

FIG. 9 is a flowchart of a method of forming a paint film on a vehicle according to this embodiment.

First, in Step S11, a paint film is formed on a first section. In this step, the paint film may be formed using an easy-to-peel paint, or by forming a transparent peelable layer and then top-coating it with a paint. When the paint film is completely formed, the process proceeds to Step S12.

In Step S12, a paint film is formed on a second section. In this step, as in Step S11, the paint film may be formed using an easy-to-peel paint, or by forming a transparent peelable layer and then top-coating it with a paint. This produces a paint film that is not continuous with the paint film of the first section. The order of execution of Steps S11 and S12 may be reversed.

As explained above, for the vehicle according to the first embodiment, in forming a paint film including an easy-to-peel layer, the section to be painted is divided into the first and second sections and the paint film is independently formed on each section. Since the paint film is divided in a spot that is invisible from the outside, the paint film remains inside when the easy-to-peel layer is removed by applying force from the outside. This makes it possible to later determine whether or not there is a history of removal of the easy-to-peel layer.

(Modification of First Embodiment)

In the first embodiment, both the first and second sections are painted with an easy-to-peel paint. However, a normal non-peelable paint may be applied to the second section. Even in such a mode, whether or not the paint film has been peeled can be later checked.

Besides, although paint films of the same color are formed on the first and second sections in the first embodiment, both sections should not necessarily be painted in the same color as long as the fact that the paint has been peeled can be confirmed.

Further, although the second section is located in a spot that is barely visible in normal use in the first embodiment, the second section may be located in a spot that can barely be reached by hands from the outside. For example, the second section may be located in a spot in the engine compartment that is inaccessible without removing a part. This can prevent removal of the paint film on the second section.

Although an independent painting step is conducted for each of the first and second sections in the first embodiment, the painting step may be conducted once and the first and second sections may be separated by cutting a slit in the formed paint film. For example, in the example shown in FIG. 4, the step of painting the hatched area and the black area integrally and the step of cutting the paint film in the spots indicated by the arrows may be implemented.

### OTHER MODIFICATIONS

The aforementioned embodiments are merely illustrative, and this disclosure may be modified and implemented as appropriate without departing from the scope thereof.

For example, the processes and means described in this disclosure may be freely combined and implemented as long as no technical contradictions arise.

What is claimed is:

1. A vehicle comprising:
a first paint film that is formed on a first section of a vehicle body and is later peelable; and
a second paint film that is formed on a second section and is not continuous with the first paint film, the second section being invisible from the outside of the vehicle body.

2. The vehicle according to claim 1, wherein
the first section is a section that is at least partially visible from the outside when an opening included in the vehicle is closed, and
the second section is a section that is entirely invisible from the outside when the opening is closed.

3. The vehicle according to claim 2, wherein
a boundary between the first section and the second section is located in a spot that is invisible from the outside.

4. The vehicle according to claim 1, wherein
the second paint film is a paint film of the same color as the first paint film.

5. The vehicle according to claim 1, wherein
the first paint film is a paint film that includes an easy-to-peel layer.

6. The vehicle according to claim 5, wherein
the first paint film is a paint film that is later removable by peeling the easy-to-peel layer.

7. The vehicle according to claim 1, wherein
the first paint film and the second paint film are laminated over an original paint film of the vehicle.

8. The vehicle according to claim 1, wherein
the second section is provided in an engine compartment.

9. The vehicle according to claim 1, wherein
the second section is provided in a luggage compartment.

10. The vehicle according to claim 1, wherein
the second section is provided in an under part of the vehicle body.

11. The vehicle according to claim 1, wherein
the second section is provided on a joint surface between the vehicle body and an exterior component.

12. A painting method comprising:
a first step of forming a first paint film that is later peelable, on a first section of a vehicle body of a vehicle; and
a second step of forming a second paint film on a second section, the second paint film not being continuous with the first paint film, the second section being invisible from the outside of the vehicle body.

13. The painting method according to claim 12, wherein
the first section is a section that is at least partially visible from the outside when an opening included in the vehicle is closed, and
the second section is a section that is entirely invisible from the outside when the opening is closed.

14. The painting method according to claim 13, wherein
a boundary between the first section and the second section is located in a spot that is invisible from the outside.

15. The painting method according to claim 12, wherein
a paint film of the same color as the first paint film is formed as the second paint film.

16. The painting method according to claim 12, wherein
the first paint film is a paint film that includes an easy-to-peel layer.

17. The painting method according to claim 16, wherein
the first paint film is a paint film that is later removable by peeling the easy-to-peel layer.

18. The painting method according to claim 12, wherein
the first paint film and the second paint film are laminated over an original paint film of the vehicle.

19. The painting method according to claim 12, wherein
the second section is provided in an engine compartment or a luggage compartment.

20. The painting method according to claim 12, wherein
the second section is provided on a joint surface between the vehicle body and an exterior component.
